(19) United States
(12) Patent Application Publication
(10) Pub. No.: US 2002/0112934 A1
(43) Pub. Date: Aug. 22, 2002

(54) Hub lock mechanism

(76) Inventors: Randy C. Karambelas, Milwaukie, OR (US); Mark J. Fogelberg, Milwaukie, OR (US); Bryan M. Averill, Portland, OR (US)

Correspondence Address: Robert L. Harrington, Suite 1920, 1211 S.W. Fifth, Portland, OR, 97204-3713, US

(21) Appl. No.: 09/790,315

(22) Filed: Feb. 21, 2001

(51) Int. Cl. B60K 23/08; F16D 11/14

(52) U.S. Cl. 192/69.43; 192/89.29; 192/93 A; 192/95; 192/109 F

(57) ABSTRACT

A hub clutch mechanism wherein actuation of the clutch ring movement is provided by an over-center spring. A first spring portion is secured to the clutch ring and a second spring portion is movably secured at the clutch ring center. The second spring portion is offset axially from the first spring portion and biases the clutch ring away from the first spring portion. Stops restrict movement of the first and second spring portions which enables movable positioning of said second spring portion from one side to the other of said first spring portion and thereby urging reverse axial movement of the clutch ring.

### FIELD OF THE INVENTION

This invention relates to a hub lock, i.e., a mechanism for locking and unlocking a hub of a wheel to and from a driven axle as when converting between two-wheel and four-wheel drive.

### BACKGROUND OF THE INVENTION

Manually operated hub locks have been used on vehicles for locking and unlocking a vehicle's front or rear wheels to the vehicle's drive train for many years. Typically, e.g., in a rear wheel driven vehicle, the rear wheels are permanently connected to the vehicle's drive train and front wheels are locked and unlocked to the drive train as desired to selectively convert between two-wheel and four-wheel drive. Commonly a clutch ring is permanently engaged with one of a wheel hub or axle and is axially movable into and out of engagement with the other. The clutch ring has splines that engage matching splines on both the wheel hub and axle. It is axially shifted by a control member, e.g., a cam, that is carried by a rotatable dial that is accessible to the vehicle's operator at the exterior of the wheel hub. By turning the dial, the cam converts the rotative motion to an axial motion that axially pushes the clutch ring.

An issue that has to be dealt with is interruption of the clutch ring movement as a result of spline misalignment (the clutch ring sliding on the hub is not aligned with the splines of the axle when engagement is urged by the cam) or spline binding (the clutch ring as fully engaged is transmitting torque between the axle and wheel hub and the resultant frictional gripping as between the splines resists axial movement of the clutch ring). Over very short periods of time (seconds), alignment will occur or binding will be released and the clutch ring is successfully moved into or out of engagement. This short period of resistance to movement of the clutch ring is accommodated by springs. For example, a first spring is interposed between the cam and clutch ring and if the splines are not aligned for engagement, cam action is completed and in the process compresses the spring against the clutch ring. When the splines become aligned, the stored energy in the spring produces the clutch ring movement. A second spring is positioned on the opposite side of the clutch ring and urges disengagement. The first spring overpowers the second spring to achieve engagement but when the cam action is reversed, the first spring retracts away from the clutch ring as the second spring then produces the urging of disengagement. If the splines are in binding relation, the second spring will maintain the urging toward disengagement until the binding relation is relieved at which point the clutch ring will be axially moved out of engagement. Such spring action can be found in numerous patents and is exemplified in U.S. Pat. No. 4,775,040.

An object of the present invention is to simplify the double spring action of the above-described hub lock and in the process to reduce costs. An additional advantage is realized in that the engagement spring is no longer required to overpower the disengagement spring and thus dial torque is reduced.

### BRIEF DESCRIPTION OF THE INVENTION

The present invention is the application of an over-center spring that supplies the spring urging of the clutch ring in both axial directions (for engagement and disengagement). The over-center spring is a planar disk shape with radially extended appendages trapped inside a groove in the inside diameter of the clutch ring. As mounted in the engaged or disengaged position, the center of the spring is offset axially from the periphery but can be forced to the other of the two positions through resisted distortion of the spring. The movement of both the clutch ring (and thus the spring periphery) and the spring center is restricted by stops. Thus, a force applied to the spring center away from a first stop is resisted by the fixed position of the clutch ring seated against an opposing stop until the center of the spring moves past the periphery of the spring. At this point, the spring action reverses and urges the spring center and the clutch ring in opposite and reversed directions to a second set of opposing stops. In a preferred embodiment, the center of the spring is secured to a plunger that is movable axially by manual operation. The center of the spring can thus be manually forced in an axial direction from one side of the periphery to the other.

The manual forcing of the spring center to one side generates an urging of the clutch ring into engagement and to the other side urges disengagement. Thus, one spring does the action of both springs in the prior hub lock devices as described above (and as exemplified in the above '040 patent).

The invention as briefly described above will be more fully understood upon reference to the following detailed description having reference to the accompanying drawings.

### BRIEF DESCRIPTION OF THE DRAWINGS

FIG. 1 is a cross sectional view of a first embodiment of the invention showing the clutch ring in the disengaged position;

FIG. 2 is a view similar to FIG. 1 showing the clutch ring in the engaged position;

FIG. 3 shows an over-center spring as incorporated into the embodiment of FIGS. 1 and 2;

FIGS. 4 and 5 are cross sectional views of a second embodiment of the invention showing the clutch ring in disengaged and engaged positions, respectively;

FIG. 6 is an exploded perspective view of the components of the embodiment of FIGS. 4 and 5;

FIG. 7 is an enlarged perspective view of the dial utilized in the second embodiment illustrating its cam features;

FIG. 8 is an enlarged perspective view of the hub cap utilized in the second embodiment illustrating its cam features;

FIGS. 9A-9F are schematic illustrations of the cooperative action of the cam features of FIGS. 7 and 8;

FIGS. 10 and 11 are cross sectional views illustrating a third embodiment of the invention wherein the clutch ring is shown in disengaged and engaged positions, respectively; and

FIG. 12 illustrates an over-center spring such as utilized in the embodiments of FIGS. 10 and 11.

### DESCRIPTION OF THE EMBODIMENTS

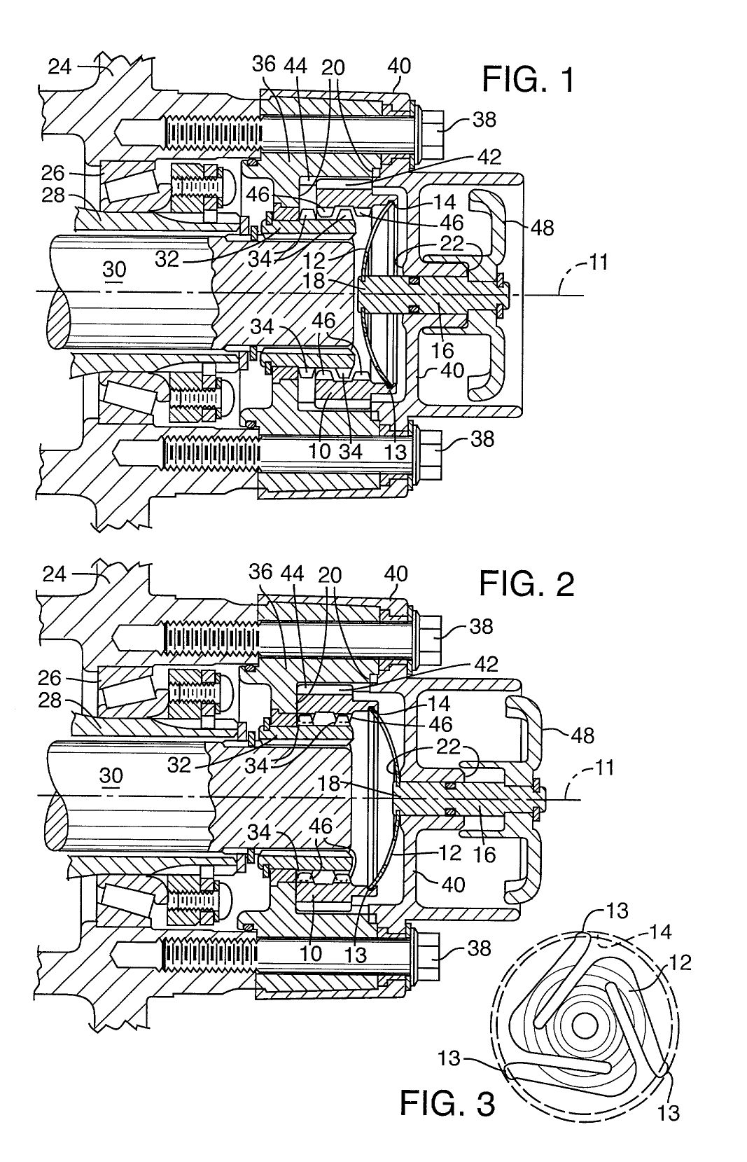

FIGS. 1 and 2 illustrate the spring action as applied to the present invention. Item 10 is a clutch ring that is slidable linearly along axis 11. Mounted inside the clutch ring 10 is an over-center spring 12 (see FIG. 3 which illustrates such a spring) Appendages 13 at the periphery of the spring 12 are captured in a circular groove 14 provided in the clutch ring 10. A plunger 16 is also movable along axis 11 and has an end 18 that attaches to the center of the spring whereby axial movement of the plunger produces axial movement of the center of the spring.

Whereas the clutch ring 10 is axially movable, it is limited in its range of movement which is illustrated in FIG. 1 by left and right stops 20 as viewed in the figures. The clutch ring is shown abutted against the right stop 20 in FIG. 1 and against the left stop 20 in FIG. 2.

Similarly, the plunger 16 (and thus the center of spring 12) is axially movable between left and right stops 22. The plunger 16 is shown abutted against right stop 22 in FIG. 1 and against left stop 22 in FIG. 2.

As shown in FIG. 1, the center of the spring 12 is at the far left position, i.e., left of groove 14 whereat the periphery of spring 12 is entrapped. The spring center is prevented from further movement to the left by right stop 22 which restricts movement of the plunger 16. The periphery of the spring which is urged away from the spring center (due to spring distortion) urges the clutch ring 10 toward the right stop 20 as also shown in FIG. 1. Forced movement of plunger 16 rightward, i.e., toward the left stop 22 forces the spring center toward the right to further distort the spring, (the spring periphery being held against rightward movement), and when the center moves past the periphery in groove 14, the spring urging reverses and pushes the clutch ring away from the spring center but toward the left. The spring center is now confined in its rightward movement by left stop 22 and the clutch ring by left stop 20 as shown in FIG. 2.

The above description does not explain the manner by which the plunger is moved. The embodiments of FIGS. 1 and 2 are referred to as a push-pull version of the hub lock mechanism of the invention. A wheel hub 24 is shown in part. Mounted in the wheel hub 24 via bearings 26 is a spindle 28 and inside the spindle an axle 30. A collar 32 is spline fit to the end of axle 30 and spline teeth 34 are provided on the exterior of the axle collar 32. The collar. 32 is an integral part of the axle as concerns the present invention.

The hub clutch mechanism of FIGS. 1 and 2 includes a hub body 36 and a hub cap 40 that is secured to the wheel hub 24 by bolts 38. The hub body is configured to receive the clutch ring 10 which has external splines 42 slidably engaging internal splines 44 of the hub body 36. The clutch ring 10 has internal spline teeth 46 which engage and disengage from the spline teeth 34 of the axle collar 32. (The double row spline teeth engagement shown in these figures is further described in U.S. Pat. No. 5,394,967.)

Mounted in the cap 40 is plunger 16 including an exterior handle or knob 48. As explained, an over-center spring 12 is fixed to the inner end of the plunger 16 at its center and is secured at its periphery in a groove 14 of the clutch ring 10. The stops 20 for the clutch ring are shoulder portions provided by the hub body 36 and hub cap 40 as illustrated. The stops 22 for the plunger 16 are opposing shoulder portions on the hub cap 40 as also illustrated.

In operation, an operator grips the knob 48 to pull the knob to the outer position as seen in FIG. 2 whereby the clutch ring is forced inwardly for clutch engagement. The plunger 16 will have moved the center of the spring 12 past its periphery and should the splines 34 and 46 not be in alignment, the spring 12 will simply continue spring pressure on the clutch ring until alignment is achieved. The clutch ring will then slide into the engaged position as shown. To disconnect, the knob 48 is pushed to the inner position as seen in FIG. 1 to place the center of the spring inwardly past its periphery at which point the spring pressure reverses and the clutch ring is forced out of engagement as illustrated in FIG. 1. In this case, if the splines 34 and 46 are in binding relation (torque trapped), the spring will remain flexed until the binding is relieved to permit disengagement.

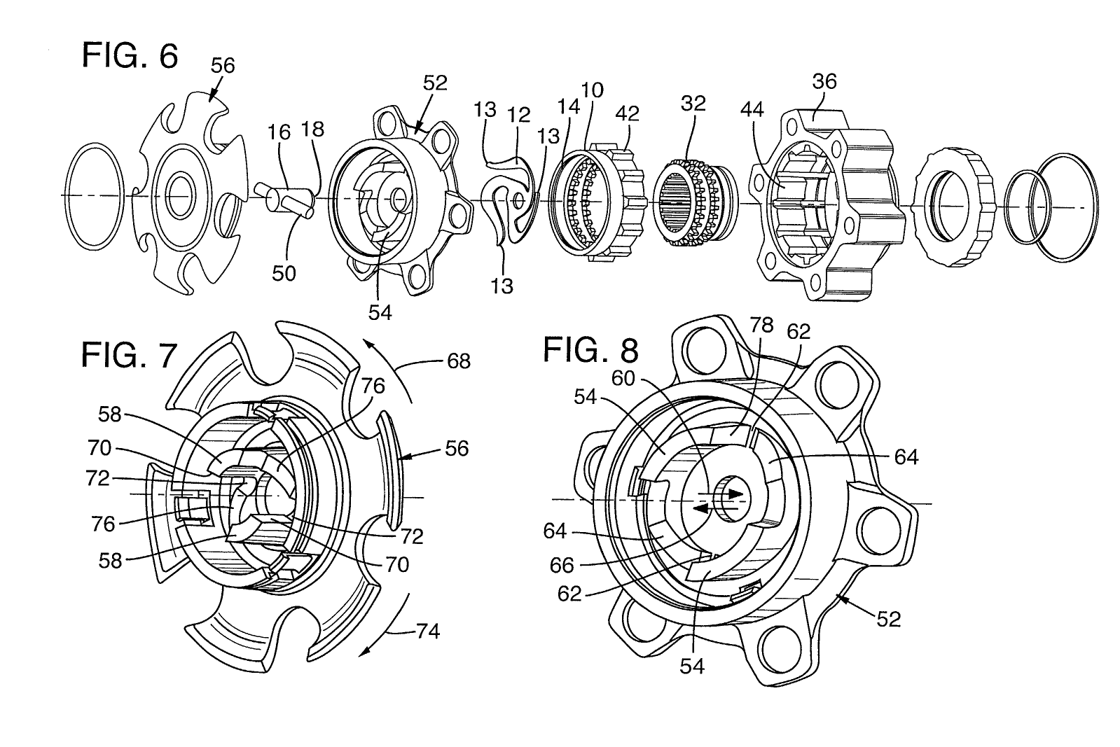

Reference is now made to FIG. 6 which illustrates the components of a second embodiment in exploded isometric view. This second embodiment is similar to that of FIGS. 2 and 3. The center of spring 12 is secured to end 18 of the plunger 16. Appendages 13 at the periphery of spring 12 are trapped in a groove 14 provided in clutch ring 10 and the clutch ring moves into and out of engagement with axle collar 32 carried by axle 30 (not shown in FIG. 6). The clutch ring 10 is slidably engaged via splines 42 with the splines 44 of the hub body 36.

Referring now to the differences, the plunger 16 is fitted with a cross pin 50 which functions as a cam follower. A hub cap 52 differentiates from the prior hub cap 40 essentially with respect to the provision of camming members 54. The knob 48 of FIG. 2 is replaced with a dial 56 provided with camming members 58 (see FIG. 7). The camming members 58 of dial 56 are designed to nest inside the camming members 54 of hub cap 52 (see FIG. 8) but with the cam follower 50 trapped between camming members 54 and 58.

FIG. 8 is an enlarged view of the hub cap 52 and its camming members 54. The camming members 54 are designed to produce retraction of the plunger via camming of the cross pin 50. Whereas the hub cap 52 and its cam members are rotatably fixed, the cross pin 50 is forced to turn relative to the cam members by the dial 56 as will be explained. Assuming that the plunger/spring center is positioned at its inner position (see arrow 60), the cross pin 50 resides at the inner most position 62. As the pin is rotated clockwise as seen in FIG. 8, the pin is forced against the cam surfaces 64 which pulls the plunger outwardly, i.e., arrow 66. As previously explained, the pulling force is only required until the spring center is forced outwardly past the spring periphery and at that point, the spring pressure reverses to move the plunger to its retracted position.

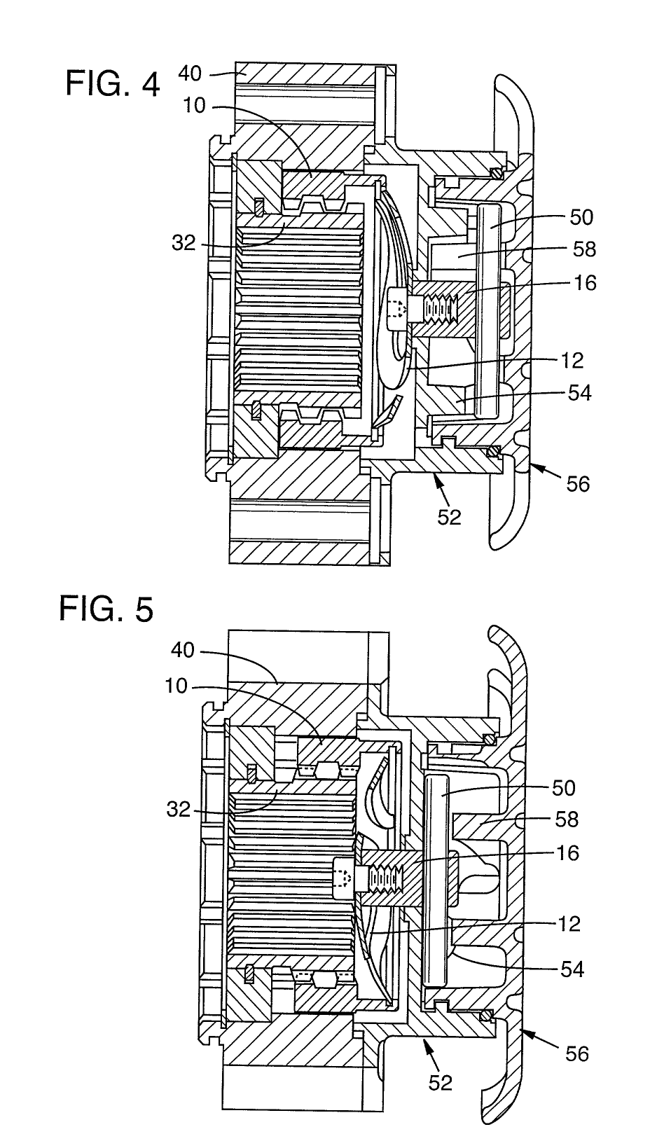

Reference is now made to FIG. 7 which illustrates the dial 56 and its cam member 58. The reader needs to understand that FIG. 8 is shown in the same view direction as FIG. 6 and FIG. 7 is the opposite view direction (to enable viewing of the cam members 58). The movement of the cross pin 50 as explained for retraction (having reference to FIG. 8) is produced by counter clockwise rotation of the dial as seen in FIG. 7 (arrow 68). Surface 70 acts against the cross pin 50 to force the pin up the surfaces 64 of the cam members 54 of hub cap 52. At completion of the plunger retraction, the pin resides at position 72. To reverse the plunger position and thus force the spring center to the inner position, the dial 56 is rotated in the clockwise direction as seen in FIG. 7 (arrow 74). Now the cross pin 50 is engaged by cam surface 76 to force the cross pin and plunger inwardly until again the center of the spring passes the spring periphery at which point the spring moves the plunger toward the inward direction thereby reversing the action of the spring as explained above. Cross sections of this second embodiment are assembled condition are shown in FIG. 4 (with the clutch ring disengaged) and FIG. 5 (with the clutch ring engaged).

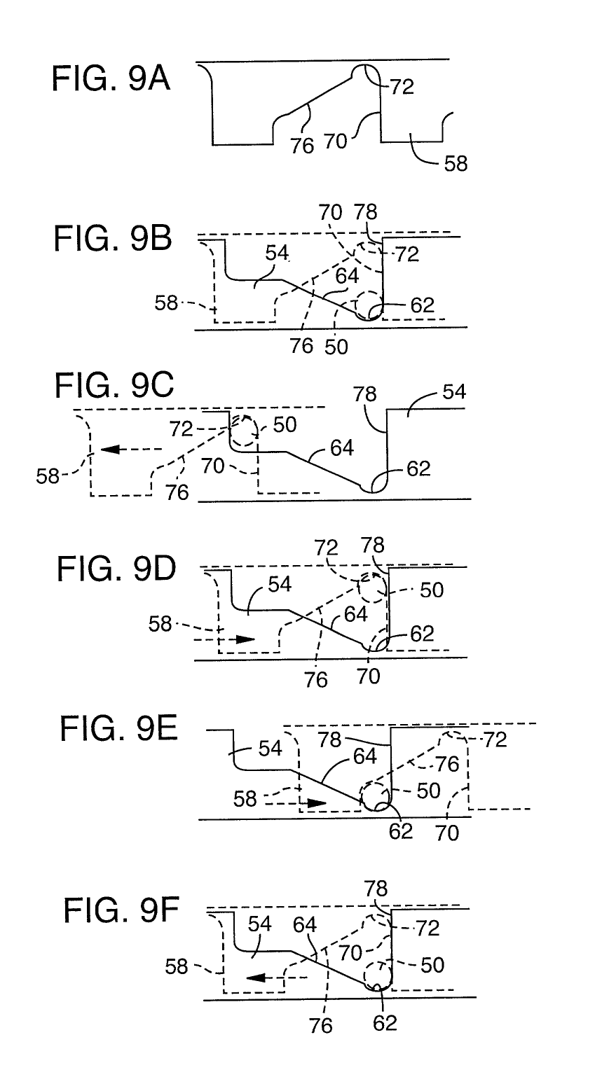

The action of the cams is further illustrated in FIGS. 9A-9F. FIG. 9A shows the profile of the dial cams 58. FIG. 9B-9F shows the profile of the hub cap cams 54 in solid lines. The dial cams 58 are superimposed onto the hub cap cams 54 (shown in dash lines) as when the dial is fitted to the hub cap. The profile of the hub cap cams 54 is shown throughout in a fixed position whereas the dial cams 58 are shown being shifted to the left (FIG. 9B and 9C) and then to the right (FIG. 9D and 9E) for moving the cross pin 50 upward (outward) and then downward (inward). As shown in FIG. 9B, the cross pin 50 is at the inner position 62, i.e., the engaged position of FIG. 5. Shifting the cams 58 to the left causes face 70 to force the pin 50 up ramp surface 64, i.e., to the outer position seen in FIG. 9C, i.e., its disengaged position of FIG. 4. Reverse shifting of cam 58 produces rightward movement of cross pin 50 until it abuts face 78 as seen in FIG. 9D. Further rightward movement forces the cross pin 50 to slide downwardly along cam surface 76 to the inner position as seen in FIG. 9E (the engaged position). The cross pin 50 remains at the inner position until the cams 58 are again shifted to the left bringing engagement of surface 70 back into engagement with the cross pin 50 as seen in FIG. 9F, the same position as indicated for FIG. 9B.

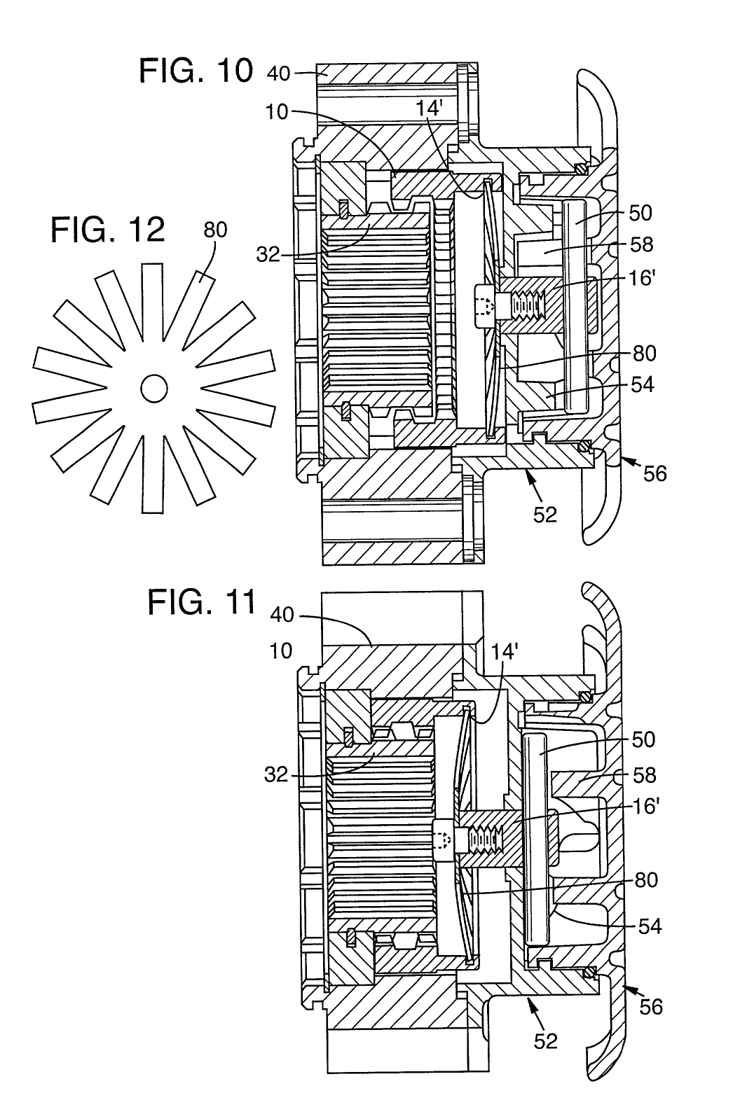

Reference is now made to Figs, 10, 11 and 12 which illustrate an alternative embodiment of the invention. Rather than an over-center spring as illustrated for FIGS. 1-6, FIGS. 10 and 11 utilize a stiff leaf spring 80 as shown in FIG. 12. This embodiment is similar in structure to the over-center spring embodiment but functions in a manner that is reverse to that of FIGS. 1-6. The leaf spring 80 urges the clutch ring in the same direction as the spring center is moved. FIG. 11 shows the plunger 16′ moving the leaf spring 80 to the left to urge clutch ring engagement. When moved to the right, the clutch ring is similarly moved to the right for disengagement as seen in FIG. 10. When movement of the clutch ring is resisted, e.g., by misalignment as when urging the clutch ring to the left, or upon binding when urged to the right, the spring simply deflects.

It will be appreciated that the slots 14′ in the clutch ring are sufficiently deep to allow the spring to pull out and push into the slot as the spring is bowed and then straightened but without pulling the spring periphery totally out of the slots. Also, this version requires that the plunger 16′ be held in the extreme positions, engaged or disengaged positions, which is accomplished by detents. The detents can be provided in the cam surfaces of cams 54 and 58 in the hub body or dial, respectively.

Whereas the above invention is described in connection with specific embodiments of the invention, those skilled in the art will appreciate the application of the invention to various modifications. Accordingly, the invention is to be determined based on the scope of the claims appended thereto. Specifically, the claims are not intended to be interpreted under 35 USC §112, ¶6.

What is claimed is:

1. A hub clutch mechanism comprising an axle having an axle end portion, a hub body surrounding the axle end portion, a clutch ring engaging one of the axle end portion and the hub body and slidably movable axially into engagement with the other of the axle end portion and hub body, and a control member controlling the slidable movement of said clutch ring which comprises:
an over-center spring having a periphery secured to said clutch ring and as secured to said clutch ring said clutch ring is urged away from the center of the spring in an axial direction, and an operative force member selectively applied to said center to force said center to one side and then the other side of said periphery to reverse axial urging of said clutch ring into and out of engagement.

2. A hub clutch mechanism as defined in claim 1 wherein the operative force member is an axially movable plunger secured at one end to the center of the spring and including a knob at the other end and accessible for manually induced movement of the plunger.

3. A hub clutch mechanism as defined in claim 1 wherein the operative force member is an axially movable plunger provided with a cam follower, a rotatable dial having cam surfaces engaging said cam follower whereby rotation of the dial in one direction forces axial movement of the plunger in one axial direction and rotation of the dial in the other rotative direction forces axial movement of the plunger in the other axial direction.

4. A hub clutch mechanism as defined in claim 3 wherein said control member includes fixed cam surfaces in cooperative relation to the cam surfaces of the dial for cooperative selective camming of the cam follower in the opposed directions for engagement and disengagement by the clutch ring.

5. A hub clutch mechanism as defined in claim 1 including first inner and outer stops that confine the axial movement of the center of the spring and second inner and outer stops that confine the axial movement of the clutch ring.

6. A hub clutch mechanism as defined in claim 5 wherein the second stops restrict movement of the clutch ring at the point of engagement by the periphery of the spring to axial movement inside the positions of axial movement of the spring center.

7. A hub clutch mechanism as defined in claim 6 wherein the restricted movement of the clutch ring is substantially about half the movement of the spring center.

8. A hub clutch mechanism comprising an axle having an axle end portion, a hub body surrounding the axle end portion, a clutch ring engaging one of the axle end portion and the hub body and slidably movable axially into engagement with the other of the axle end portion and hub body, and a control member controlling the slidable movement of said clutch ring which comprises:
a spring having a center portion and a periphery, said periphery secured to said clutch ring, an elongate force member slidable axially relative to said clutch ring, said force member secured to said center portion of the spring at one end, and the other end extended axially outward of said hub body and accessible to manual axial movement whereby such axial movement moves the center portion of the spring and urges axial movement of the periphery and thus the clutch ring.

9. A hub clutch mechanism as defined in claim 8 wherein a manually rotatable dial is provided in the hub body, said dial including cam members engaging said elongate force member for converting rotative movement of the dial to axial movement of the force member.

10. A hub clutch mechanism as defined in claim 9 including detents provided in said cam members for holding the force member at the extreme axial positions until overcome by reverse manual manipulation of the dial.
